(19) United States
(12) Patent Application Publication
(10) Pub. No.: US 2025/0092237 A1
(43) Pub. Date: Mar. 20, 2025

(54) BIMODAL MEDIUM DENSITY POLYETHYLENE COMPOSITIONS

(71) Applicant: Dow Global Technologies LLC, Midland, MI (US)

(72) Inventors: Bhawesh Kumar, Sugar Land, TX (US); Rujul M. Mehta, Manvel, TX (US); Alex Stolarz, Walenstadtberg (CH); Rachel C. Anderson, Midland, MI (US); Mridula Kapur, Lake Jackson, TX (US); Lalit A. Darunte, Sunnyvale, CA (US); Stephanie M. Whited, South Charleston, WV (US)

(21) Appl. No.: 18/729,232

(22) PCT Filed: Feb. 9, 2023
(86) PCT No.: PCT/US2023/062248

§ 371 Date: Jul. 16, 2024

Related U.S. Application Data
(60) Provisional application No. 63/267,846, filed on Feb. 11, 2022.

(51) Int. Cl. C08L 23/0807; A01G 25/02

(52) U.S. Cl. CPC C08L 23/0815; A01G 25/02; C08L 2205/025

(57) ABSTRACT

Provided are bimodal medium density polyethylene compositions, and microirrigation drip tapes including the same. The bimodal medium density polyethylene compositions can be extruded at higher lines speed while maintaining other desirable properties. The bimodal medium density polyethylene compositions include a high molecular weight (HMW) polyethylene component and a low molecular weight (LMW) polyethylene component. In some embodiments, the bimodal medium density polyethylene composition has a density of from 0.937 to 0.949 g/cm³; a high load melt index (I21) from 12 to 30 g/10 min: a crossover G′=G″ of from 30 to 45 kPa; and a calculated LMW density of the LWM polyethylene component of less than or equal to 0.974 g/cm³.

### TECHNICAL FIELD

Embodiments of the present disclosure generally relate to bimodal medium density polyethylene compositions, and microirrigation drip tapes including the same.

### INTRODUCTION

A microirrigation drip tape is a tube for transporting and dripping water, fertilizer, and/or nutrition in irrigation systems. The annual United States microirrigation drip tape market consumes over 120 MM lbs. of polyethylene resins. Currently, microirrigation drip tapes are primarily formed from unimodal polyethylene resins with densities between 0.939 to 0.944 g/cm³, a melt index (I2) of 0.2 to 0.3 g/10 min, and a molecular weight distribution of greater than 15. Existing polyethylene resins, however, have limited processability because the resins lack properties that do not allow processors to produce microirrigation drip tapes with a suitable wall thickness while maintaining tensile strength and service life. Accordingly, there remains a need for polyethylene compositions suitable for use in microirrigation drip tapes that have desirable processability (e.g., can be processed faster for cheaper manufacturing costs) and have maintained or improved tensile strength and service life as indicated by notched constant tensile load failure time.

### SUMMARY

Embodiments of the present disclosure meet one or more of the foregoing needs by providing a bimodal medium density polyethylene composition that can be processed at higher extrusion speeds and can exhibit improved or maintained tensile strength and notched constant tensile load failure time. Without being bound by any theory, in some embodiments, the bimodal medium density polyethylene composition has specific properties, including, for example, a crossover G′=G″ (which is indicative of melt elasticity) and a calculated low molecular weight density, that can allow the composition to be extruded at higher speeds when compared to prior art compositions. The specific properties of the bimodal medium density polyethylene compositions, including its bimodality and calculated low molecular weight density, can in some embodiments contribute to the maintained or improved service life of the bimodal medium density polyethylene composition.

Disclosed herein are bimodal medium density polyethylene compositions. In one or more embodiments, the bimodal medium density polyethylene composition comprises (i) a high molecular weight (HMW) polyethylene component comprising an ethylene/α-olefin copolymer; and (ii) a low molecular weight (LMW) polyethylene component comprising an ethylene/α-olefin copolymer; the bimodal medium density polyethylene composition having the following: (a) a density of from 0.937 to 0.949 g/cm³; (b) a high load melt index (I21) from 12 to 30 g/10 min; (c) an isothermal crystallization half-time at Tc+5° C. of greater than 350 seconds; (d) an extensional strain at break of greater than 3.6; (e) a crossover G′=G″ of from 30 to 45 kPa; and (f) a calculated LMW density of the LMW polyethylene component of less than or equal to 0.974 g/cm³; and wherein the crossover G′=G″ and the calculated LMW density satisfy the following equation: [43.0−Crossover G′=G″]+1230. (0.9731−Calculated LMW Density)−5.5745≥0.

In one or more embodiments, the bimodal medium density polyethylene composition comprises (i) a high molecular weight (HMW) polyethylene component comprising an ethylene/α-olefin copolymer; and (ii) a low molecular weight (LMW) polyethylene component comprising an ethylene/α-olefin copolymer; the bimodal medium density polyethylene composition having the following: (a) a density of from 0.937 to 0.949 g/cm³; (b) a high load melt index (I21) from 12 to 30 g/10 min; (c) an isothermal crystallization half-time at Tc+5° C. of greater than 360 seconds; (d) an extensional strain at break of greater than 3.6; (e) a crossover G′=G″ of from 30 to 45 kPa; (f) an average short chain branching (SCB) frequency of from 2.4 to 10.0 SCB per 1000 carbons; and (g) an average short chain branching (SCB) frequency of the LMW polyethylene component of from 2.0 to 8.7 SCB per 1000 carbons; and wherein the crossover G′=G″ and the average short chain branching (SCB) frequency of the LMW polyethylene component satisfy the following equation:

$$[ 43. - Crossover {G}^{′} = {G}^{″} ] - ( \frac{54.4}{LMW SCB} ) + 16.9 \geq 0.$$

Also disclosed herein are microirrigation drip tapes. The microirrigation drip tapes comprise the bimodal medium density polyethylene compositions disclosed herein.

These and other embodiments are described in more detail in the Detailed Description.

### BRIEF DESCRIPTION OF THE DRAWINGS

FIG. 1 is a perspective view of a microirrigation drip tape with a round cross section.

FIG. 2 is a plot of isothermal crystallization half time (ICHT) measured at temperatures 3 to 5° C. above the crystallization temperature Tc.

### DETAILED DESCRIPTION

Aspects of the disclosed bimodal medium density polyethylene compositions are described in more detail below. The bimodal medium density polyethylene compositions are suitable for use as a microirrigation drip tapes and can have a wide variety of applications, including, for example, pipes, hoses, tapes, or the like. This disclosure, however, should not be construed to limit the embodiments set forth below as this disclosure is an illustrative implementation of the embodiments described herein.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “copolymer” means a polymer formed by the polymerization reaction of at least two structurally different monomers. The term “copolymer” is inclusive of terpolymers.

As used herein, the terms “polyethylene” or “ethylene-based polymer” shall mean polymers comprising a majority amount (>50 mol %) of units which have been derived from ethylene monomer. This includes polyethylene homopolymers and copolymers (meaning units derived from two or more comonomers). The terms “ethylene-based polymer” and “polyethylene” may be used interchangeably. Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

As used herein, the term “composition” refers to a mixture of materials which comprise the composition, as well as reaction products and decomposition products formed from the materials of the composition.

As used herein, the term “backbone” refers to the longest continuous polymeric chain of a polymer. All other polymer chains are referred to as side chains, branches, or grafted polymer chains. As used herein, the term “short chains” or “short chain branching” (SCB) refers to branches from the backbone resulting from polymerization of monomers containing three or more carbons.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

A bimodal medium density polyethylene composition of the present invention can comprise a combination of two or more embodiments as described herein. Some embodiments of the present invention relate to microirrigation drip tapes. A microirrigation drip tape according to embodiments of the present invention comprises a bimodal medium density polyethylene composition according to any of the inventive embodiments disclosed herein. A microirrigation drip tape of the present invention can comprise a combination of two or more embodiments as described herein.

Disclosed herein are bimodal medium density polyethylene compositions. As used herein, a medium density polyethylene composition is a polyethylene composition having a density of from 0.937 to 0.949 g/cm³. The bimodal medium density polyethylene composition according to embodiments disclosed herein comprises a high molecular weight (HMW) polyethylene component and a low molecular weight (LMW) polyethylene component. The HMW polyethylene component has a higher molecular weight than the LMW polyethylene component.

The bimodal medium density polyethylene composition according to embodiments disclosed herein is bimodal. A “bimodal” polyethylene composition contains two polyethylene fractions (e.g., a HMW polyethylene component and a LMW polyethylene component) that have been produced under different polymerization conditions, including differences in any process conditions and/or catalyst systems, resulting in different molecular weights and/or different comonomer contents for the fractions. According to embodiments disclosed herein, the first polyethylene fraction is the HMW polyethylene component and the second polyethylene fraction is the LMW polyethylene component. The bimodal medium density polyethylene composition may be a mechanical blend or an in-reactor blend of the high molecular weight polyethylene component and the low molecular polyethylene component. In an embodiment, the bimodal medium density polyethylene composition is an in-reactor blend of the HMW polyethylene component and the LMW polyethylene component. For avoidance of any doubt, the bimodal medium density polyethylene composition disclosed herein excludes and is not a unimodal polyethylene having a single polyethylene fraction.

### HMW Polyethylene Component

The bimodal medium density polyethylene composition comprises a HMW polyethylene component. In some embodiments, the HMW component comprises an ethylene/α-olefin copolymer.

In some embodiments, the ethylene/α-olefin copolymer of the HMW polyethylene component comprises ethylene and an α-olefin comonomer. Nonlimiting examples of suitable α-olefins include C3-C20 α-olefins, or C4-C20 α-olefins, or C3-C10 α-olefins, or C4-C10 α-olefins, or C4-C8 α-olefins. Representative α-olefins include propylene, 1-butene, 1-pentene, 1-hexene, 1-heptene and 1-octene. In an embodiment, the ethylene/α-olefin copolymer does not contain an aromatic comonomer polymerized therein. In a further embodiment, the ethylene/α-olefin copolymer is an ethylene/1-hexene copolymer. In an embodiment, the ethylene/α-olefin copolymer consists of ethylene, the C4-C8 α-olefin comonomer, and optional additive.

In an embodiment, the ethylene/α-olefin copolymer contains greater than 50 wt. % units derived from ethylene, or from 51 wt. %, or 55 wt. %, or 60 wt. % to 70 wt. %, or 80 wt. %, or 90 wt. %, or 95 wt. % units derived from ethylene, based on the weight of the ethylene/α-olefin copolymer. In an embodiment, the ethylene/α-olefin copolymer contains a reciprocal amount of units derived from an α-olefin comonomer, or from less than 50 wt. %, or 49 wt. %, or 45 wt. %, or 40 wt. % to 30 wt. %, or 20 wt. %, or 10 wt. %, or 5 wt. % units derived from an α-olefin comonomer, based on the weight of the ethylene/α-olefin copolymer. Comonomer content may be measured using any suitable technical, such as techniques based on nuclear magnetic resonance (“NMR”) spectroscopy, and, for example, by 13C NMR analysis as described in U.S. Pat. No. 7,498,282, which is incorporated herein by reference.

In some embodiments, the HMW polyethylene component has a density of from 0.914 to 0.935 g/cm³. All individual values and subranges of 0.914 to 0.935 g/cm³ are disclosed and included herein. For example, the HMW polyethylene component can have a density of from 0.914 to 0.934 g/cm³, 0.916 to 0.934 g/cm³, 0.915 to 0.933 g/cm³, 0.917 to 0.935 g/cm³, 0.920 to 0.935 g/cm³, 0.922 to 0.935 g/cm³, 0.924 to 0.935 g/cm³, 0.926 to 0.935 g/cm³, 0.928 to 0.935 g/cm³, or 0.930 to 0.935 g/cm³, where density of the HMW polyethylene component is measured in accordance with ASTM D792.

In some embodiments, the HMW polyethylene component has a high load melt index (I21) of from 0.5 to 0.9 g/10 min. All individual values and subranges of 0.5 to 0.9 g/10 min are disclosed and included herein. For example, the HMW polyethylene component can have a high load melt index (I21) of from 0.5 to 0.8 g/10 min, from 0.5 to 0.7 g/10 min, from 0.5 to 0.9 g/10 min, from 0.6 to 0.9 g/10 min, from 0.6 to 0.8 g/10 min, or from 0.7 to 0.8 g/10 min, where high load melt index (I21) of the HMW polyethylene component is measured in accordance with ASTM D1238 (190° C./21.6 kg).

In some embodiments, the HMW polyethylene component has a high load melt index (I21) of from 0.5 to 0.9 g/10 min and/or has a density of from 0.914 to 0.935 g/cm³.

In some embodiments, the HMW polyethylene component is present in an amount of from 48 to 60 wt. %, based on total weight of the bimodal medium density polyethylene composition. All individual values and subrange of from 48 to 60 wt. % are included and disclosed herein. For example, the HMW polyethylene component can be present in an amount of from 48 to 60 wt. %, from 50 to 60 wt. %, from 52 to 60 wt. %, from 53 to 60 wt. %, from 48 to 58 wt. %, from 48 to 56 wt. %, from 50 to 58 wt. %, from 50 to 56 wt. %, from 52 to 58 wt. %, or from 52 to 56 wt. %, based on total weight of the bimodal medium density polyethylene composition.

In some embodiments, the HMW polyethylene component has an average short chain branching (SCB) frequency of from 2.3 to 10.0 SCB per 1000 carbons. All individual values and subranges of from 2.3 to 10.0 SCB per 1000 carbons are disclosed and included herein. For example, the HMW polyethylene component can have an average short chain branching frequency of from 2.4 to 9.5 SCB per 1000 carbons, from 2.5 to 9.2 SCB per 1000 carbons, from 2.6. to 9.0 SCB per 1000 carbons, from 2.6 to 4.9 SCB per 1000 carbons, from 2.6 to 4.8 SCB per 1000 carbons, from 2.6 to 4.7 SCB per 1000 carbons, from 2.6 to 4.6 SCB per 1000 carbons, or from 2.6 to 4.5 SCB per 1000 carbons, where average short chain branching (SCB) frequency can be measured in accordance with the test method described below.

In some embodiments, the HMW polyethylene component has a weight average molecular weight, Mw, of from 300,000 to 550,000 g/mol. All individual values and subranges of from 300,000 to 550,000 g/mol are disclosed and included herein. For example, the HMW polyethylene component can have a weight average molecular weight, Mw, of from 325,000 to 475,000 g/mol, from 350,000 to 450,000 g/mol, or from 350,000 to 425,000 g/mol, where weight average molecular weight, Mw, can be measured in accordance with the GPC test method described below.

### LMW Polyethylene Component

The bimodal medium density polyethylene composition comprises a LMW polyethylene component. In some embodiments, the LMW component comprises an ethylene/α-olefin copolymer.

In some embodiments, the ethylene/α-olefin copolymer of the LMW polyethylene component comprises ethylene and an α-olefin comonomer. Nonlimiting examples of suitable α-olefins include C3-C20 α-olefins, or C4-C20 α-olefins, or C3-C10 α-olefins, or C4-C10 α-olefins, or C4-C8 α-olefins. Representative α-olefins include propylene, 1-butene, 1-pentene, 1-hexene, 1-heptene and 1-octene. In an embodiment, the ethylene/α-olefin copolymer does not contain an aromatic comonomer polymerized therein. In a further embodiment, the ethylene/α-olefin copolymer is an ethylene/1-hexene copolymer. In an embodiment, the ethylene/α-olefin copolymer consists of ethylene, the C4-C8 α-olefin comonomer, and optional additive.

In an embodiment, the ethylene/α-olefin copolymer of the LMW polyethylene component contains greater than 50 wt. % units derived from ethylene, or from 51 wt. %, or 55 wt. %, or 60 wt. % to 70 wt. %, or 80 wt. %, or 90 wt. %, or 95 wt. %, or 99 wt. % units derived from ethylene, based on the weight of the ethylene/α-olefin copolymer. In an embodiment, the ethylene/α-olefin copolymer contains a reciprocal amount of units derived from an α-olefin comonomer, or from less than 50 wt. %, or 49 wt. %, or 45 wt. %, or 40 wt. % to 30 wt. %, or 20 wt. %, or 10 wt. %, or 5 wt. %, or 1 wt. % units derived from an α-olefin comonomer, based on the weight of the ethylene/α-olefin copolymer.

The ethylene/α-olefin copolymer of the LMW polyethylene component and the ethylene/α-olefin copolymer of the HMW polyethylene component differ in at least the molecular weight of the respective component. In an embodiment, the LMW polyethylene component has a weight average molecular weight, Mw, that is less than the weight average molecular weight, Mw, of the HMW polyethylene component, and the LMW polyethylene component has a density that is greater than the density of the HMW polyethylene component.

The LMW polyethylene component has a calculated LMW density. In some embodiments, a calculated LMW density of the LMW polyethylene component is less than or equal to 0.974 g/cm³. All individual values and subranges of less than or equal to 0.974 g/cm³ are disclosed and included herein. For example, the LMW polyethylene component can have a calculated LMW density of less than or equal to 0.973 g/cm³, less than or equal to 0.972 g/cm³, less than or equal to 0.971 g/cm³, less than or equal to 0.969 g/cm³, less than or equal to 0.968 g/cm³, less than or equal to 0.967 g/cm³, less than or equal to 0.966 g/cm³, less than or equal to 0.965 g/cm³, or less than or equal to 0.964 g/cm³; or in the range of from 0.960 to 0.973 g/cm³, from 0.960 to 0.972 g/cm³, from 0.960 to 0.971 g/cm³, or from 0.960 to 0.970 g/cm³. The calculated LMW density of the LMW polyethylene component is calculated using Eq. 1:

$$Calculated LMW Density = \frac{( 1 - HMW wt . fraction )}{( \frac{1}{Density} - \frac{HMW wt . fraction}{HMW density} )} \qquad Eq . 1$$

where “HMW density” is the density of the HMW polyethylene component, “HMW wt. fraction” is the weight fraction of the HMW polyethylene component, and “Density” is the density of the bimodal medium density polyethylene composition.

In some embodiments, the LMW polyethylene component has an average short chain branching (SCB) frequency of from 2.0 to 8.7 SCB per 1000 carbons. All individual value and subranges of from 2.0 to 8.7 SCB per 1000 carbons are disclosed and included herein. For example, the LMW polyethylene component can have an average short chain branching (SCB) frequency of from 2.0 to 8.5 SCB per 1000 carbons, from 2.0 to 8.3 SCB per 1000 carbons, from 2.0 to 8.1 SCB per 1000 carbons, from 2.0 to 7.9 SCB per 10000 carbons, from 2.0 to 7.7 SCB per 1000 carbons, from 2.2 to 7.5 SCB per 1000 carbons, from 2.4 to 7.5 SCB per 1000 carbons, from 2.6 to 7.3 SCB per 1000 carbons, from 2.8 to 7.2 SCB per 1000 carbons, or from 2.9 to 7.3 SCB per 1000 carbons, where average short chain branching (SCB) frequency can be measured in accordance with the test method described below.

In some embodiments, the LMW polyethylene component has a weight average molecular weight, Mw, of from 15,000 to 40,000 g/mol. All individual values and subrange of from 15,000 to 40,000 g/mol are disclosed and included herein. For example, the LMW polyethylene component can have a weight average molecular weight, Mw, of from 20,000 to 40,000 g/mol, from 20,000 to 35,000 g/mol, or from 20,000 to 30,000 g/mol, where weight average molecular weight, Mw, can be measured in accordance with the GPC test method described below.

In some embodiments, the ratio of the average short chain branching frequency of the LMW polyethylene component to the average short chain branching frequency of the HMW polyethylene component (LMW SCB/HMW SCB) is greater than 0.7. All individual values and subranges of greater than 0.7 are included and disclosed herein. For example, the ratio of the average short chain branching frequency of the LMW polyethylene component to the average short chain branching frequency of the HMW polyethylene component (LMW SCB/HMW SCB) can be greater than 0.75 or greater than 0.80, or can be in the range of from 0.75 to 2.00 or from 0.75 to 1.80.

### Bimodal Medium Density Polyethylene Composition Characteristics

In some embodiments, the bimodal medium density polyethylene composition has a density of from 0.937 to 0.949 g/cm³, an overall high load melt index (I21) from 12 to 30 g/10 min, and a crossover G′=G″ of from 30 to 45 kPA.

In some embodiments, the bimodal medium density polyethylene composition has a density of from 0.937 to 0.949 g/cm³. All individual values and subranges of from 0.937 to 0.949 g/cm³ are disclosed and included herein. For example, the bimodal medium density polyethylene composition can have a density of from 0.938 to 0.949 g/cm³, from 0.939 to 0.949 g/cm³, from 0.940 to 0.949 g/cm³, from 0.941 to 0.949 g/cm³, from 0.942 to 0.949 g/cm³, from 0.938 to 0.947 g/cm³, from 0.940 to 0.947 g/cm³, from 0.941 to 0.947 g/cm³, or from 0.943 to 0.947 g/cm³, where density is measured in accordance with ASTM D792.

In some embodiments, the bimodal medium density polyethylene composition has a high load melt index (I21) from 12 to 30 g/10 min. All individual values and subranges of from 12 to 30 g/10 min are disclosed and included herein. For example, the bimodal medium density polyethylene composition can have a high load melt index (I21) of from 12 to 28 g/10 min, from 12 to 26 g/10 min, from 12 to 24 g/10 min, from 14 to 30 g/10 min, from 14 to 28 g/10 min, from 14 to 26 g/10 min, or from 14 to 24 g/10 min, where high load melt index (I21) of the bimodal medium density polyethylene composition is measured in accordance with ASTM D1238 (190° C./21.6 kg).

In some embodiments, the bimodal medium density polyethylene composition has a crossover G′=G″ of from 30 to 45 Kilopascal (kPa). All individual values and subranges of from 30 to 45 kPa are disclosed and included herein. For example, the bimodal medium density polyethylene composition can have a crossover G′=G″ of from 32 to 45 kPa, from 30 to 43 kPa, from 34 to 45 kPa, or from 30 to 42 kPa, where crossover G′=G″ is measured in accordance with the test method described below.

In some embodiments, the crossover G′=G″ and the calculated LMW density satisfy the following equation (Eq. 2):

$$[ 43. - Crossover {G}^{′} = {G}^{″} ] + 1230 ( 0.9731 - Calculated LMW Density ) - 5.5745 \geq 0 \qquad Eq . 2$$

where “Crossover G′=G″” is the crossover G′=G″ of the bimodal medium density polyethylene composition and “Calculated LMW Density” is the calculated LMW density of the LMW polyethylene component. In some embodiments, the left side of Eq. 2 is greater than or equal to 1, or greater than or equal to 2, or greater than or equal to 3, or greater than or equal to 4.

In some embodiments, the crossover G′=G″ and the average short chain branching frequency of the LMW polyethylene component satisfy the following equation (Eq. 3):

$$[ 43. - Crossover {G}^{′} = {G}^{″} ] - ( \frac{54.5}{L M W S C B} ) + 16.9 \geq 0 \qquad Eq . 3$$

where “Crossover G′=G″” is the crossover G′=G″ of the bimodal medium density polyethylene composition and “LMW SCB” is the average short chain branching frequency of the LMW polyethylene component. In some embodiments, the left side of Eq. 3 is greater than or equal to 1, or greater than or equal to 2, or greater than or equal to 3, greater than or equal to 4, greater than or equal to 5, or greater than or equal to 6.

In some embodiments, the bimodal medium density polyethylene composition has a molecular weight distribution, Mw/Mn, of from 12 to 30. All individual values and subranges of from 12 to 30 are included herein. For example, the bimodal medium density polyethylene composition can have a molecular weight distribution, Mw/Mn, of from 12 to 28, from 12 to 26, from 12 to 24, from 12 to 22, from 12 to 20, from 14 to 28, from 14 to 26, from 14 to 24, from 14 to 22, or from 14 to 20, where molecular weight distribution, Mw/Mn, can be measured in accordance with the test method described below.

In some embodiments, the bimodal medium density polyethylene composition has an average short chain branching (SCB) frequency of from 2.4 to 10.0 SCB per 1000 carbons. All individual value and subrange of from 2.4 to 10.0 SCB per 1000 carbons are disclosed and included herein. For example, the bimodal medium density polyethylene composition can have an average short chain branching (SCB) frequency of from 2.4 to 9.5 SCB per 1000 carbons, 2.6 to 9.5 SCB per 1000 carbons, 2.8 to 9.5 SCB per 1000 carbons, 3.0 to 9.5 SCB per 1000 carbons, from 3.5 to 9.5 SCB per 1000 carbons, from 3.0 to 9.0 SCB per 1000 carbons, or from 3.5 to 9.0 SCB per 1000 carbons, where average short chain branching (SCB) frequency can be measured in accordance with the test method described below.

In some embodiments, the bimodal medium density polyethylene composition has a notched constant tensile load (NCTL) failure time at 30% yield stress of greater than 100 hours. In some embodiments, the bimodal medium density polyethylene composition has a NCTL failure time at 30% yield stress of greater than 110 hours, or 120 hours, or 140 hours, or 160 hours, or 180 hours, where NCTL failure time at 30% yield stress is measured in accordance with the test method described below.

In some embodiments, the bimodal medium density polyethylene composition has a tensile stress at yield of from 19 to 28 MPa. All individual values and subranges for from 19 to 28 MPa are disclosed and included herein. For example, the bimodal medium density polyethylene composition can have a tensile stress at yield of from 19 to 27 MPa, from 19 to 26 MPa, from 19 to 25 MPa, from 19 to 24 MPa, from 20 to 27 MPa, from 20 to 26 MPa, from 20 to 25 MPa, or from 20 to 24 MPa, where tensile stress at yield is measured in accordance with the test method described below.

In some embodiments, the bimodal medium density polyethylene composition has a DSC melting temperature, Tm, in the range of from 125 to 135° C. All individual values and subranges of from 125 to 135° C. are disclosed and included herein. For example, the bimodal medium density polyethylene composition can have a DSC melting temperature, Tm, in the range of from 126 to 134° C., from 127 to 133° C., from 125 to 132° C., from 125 to 131° C., or from 125 to 130° C., where DSC melting temperature, Tm, can be measured in accordance with the test method described below.

In some embodiments, the bimodal medium density polyethylene composition has a DSC crystallization temperature, Tc, in the range of from 110 to 125° C. All individual values and subranges of from 110 to 125° C. are disclosed and included herein. For example, the bimodal medium density polyethylene composition can have a DSC crystallization temperature, Tc, in the range of from 111 to 124° C., from 113 to 122° C., from 115 to 120° C., or from 116 to 118° C., where DSC crystallization temperature, Tc, can be measured in accordance with the test method described below.

In some embodiments, the bimodal medium density polyethylene composition has an isothermal crystallization half-time at Tc+5° C. of greater than 360 seconds (sec). All individual values and subranges of greater than 360 seconds are disclosed and included herein. For example, the bimodal medium density polyethylene composition can have an isothermal crystallization half-time at Tc+5° C. of greater than 361 seconds, greater than 362 seconds, greater than 380 second, greater than 400 seconds, or greater than 410 second, or can have an isothermal crystallization half-time at Tc+5° C. of from 360 to 500 second, where isothermal crystallization half-time at Tc+5° C. is measured in accordance with the test method described below.

In some embodiments, the bimodal medium density polyethylene composition has an extensional strain at break of greater than 3.6. All individual values and subrange of greater than 3.6 are disclosed and included herein. For example, the bimodal medium density polyethylene composition can have an extensional strain at break of greater than 3.7, greater than 3.8, greater than 3.9 or greater than 4.0, or in the range of from 3.8 to 7.0, where extensional strain at break can be measured in accordance with the test method described below.

In some embodiments, the bimodal medium density polyethylene composition is extrudable at process speeds greater than 300 m/min. In some embodiments, the bimodal medium density polyethylene composition is extrudable at process speeds greater than 325 m/min, 350 m/min, or 375 m/min, where the process speed at which the polyethylene composition is extrudable is measured in accordance with the test method described below.

The bimodal medium density polyethylene composition can be made by a variety of methods. For example, such methods may include, but are not limited to, gas phase polymerization process, slurry phase polymerization process, liquid phase polymerization process, and combinations thereof using one or more conventional reactors, e.g., fluidized bed gas phase reactors, loop reactors, stirred tank reactors, batch reactors in parallel, series, and/or any combinations thereof. In the alternative, the bimodal medium density polyethylene composition may be produced in a high pressure reactor via a coordination catalyst system. For example, the bimodal medium density polyethylene composition may be produced via gas phase polymerization process in a gas phase reactor; however, any of the above polymerization processes may be employed. In an embodiment, the polymerization reactor may comprise of two or more reactors in series, parallel, or combinations thereof, and wherein each polymerization takes place in solution, in slurry, or in the gas phase. In another embodiment, a dual reactor configuration is used where the polymer made in the first reactor can be either the high molecular weight polyethylene component or the low molecular weight polyethylene component. The polymer made in the second reactor may have a density and melt flow rate such that the overall density and melt flow rate of the bimodal medium density polyethylene composition are met. Similar polymerization processes are described in, for example, U.S. Pat. No. 7,714,072, which is incorporated herein by reference.

In an embodiment, the method of manufacturing the bimodal medium density polyethylene composition includes polymerizing a high molecular weight (HMW) polyethylene component, as previously described herein, in a reactor, and polymerizing a low molecular weight (LMW) polyethylene component, as previously described herein, in a different reactor, thereby producing a bimodal medium density polyethylene composition. The two reactors may be operated in series. In some embodiments, the high molecular weight polyethylene component is polymerized in a first reactor, and the low molecular weight polyethylene component is polymerized in a second reactor. In other embodiments, the low molecular weight polyethylene component is polymerized in a first reactor, and the high molecular weight polyethylene component is polymerized in a second reactor.

In an embodiment, the weight ratio of copolymer prepared in the high molecular weight reactor to copolymer prepared in the low molecular weight reactor is in the range of from 30:70 to 70:30, or in the range of from 40:60 to 60:40. This is also known as the polymer split.

In an embodiment, the bimodal medium density polyethylene composition is manufactured using at least one Ziegler-Natta (Z-N) catalyst system. In other embodiments, the bimodal medium density polyethylene composition is manufactured using multiple reactors in series with a Z-N catalyst being fed to either each reactor or to just the first reactor. In further embodiments, the Z-N catalyst system may be fed into one or two independently-controlled reactors configured sequentially, and operated in solution, slurry or gas phase. In even further embodiments, the Z-N catalyst system may be fed into one or two independently-controlled reactors configured sequentially, and operated in gas phase. Sequential polymerization may be conducted such that fresh catalyst is injected into one reactor, and active catalyst is carried over from the first reactor into the second reactor. The resulting bimodal medium density polyethylene composition may be characterized as comprising component polymers, each having distinct, unimodal molecular weight distributions. As used herein, “distinct,” when used in reference to the molecular weight distribution of the high molecular weight polyethylene component and the low molecular weight polyethylene component indicates there are two corresponding molecular weight distributions in the resulting GPC curve of the bimodal medium density polyethylene composition. As used herein, “unimodal,” when used in reference to the molecular weight distribution of a component polymer of the bimodal medium density polyethylene composition indicates that the molecular weight distribution in a GPC curve of the component polymer does not exhibit multiple molecular weight distributions.

The term “procatalyst” or “precursor”, are used interchangeably herein, and denote a compound including a ligand, a transition metal, and optionally, an electron donor. The procatalyst may further undergo halogenation by contacting with one or more halogenating agents. A procatalyst can be converted into a catalyst upon activation. Such catalysts are commonly referred to as Ziegler-Natta catalysts. Suitable Zeigler-Natta catalysts are known in the art and include, for example, the catalysts taught in U.S. Pat. Nos. 4,302,565; 4,482,687; 4,508,842; 4,990,479; 5,122,494; 5,290,745; and, 6,187,866 B1, the disclosures of which are hereby incorporated by reference. The collection of catalyst components, such as procatalyst(s), cocatalyst(s), is referred to as a catalyst system.

The transition metal compound of the procatalyst composition can include compounds of different kinds. The most usual are titanium compounds-organic or inorganic-having an oxidation degree of 3 or 4. Other transition metals such as, vanadium, zirconium, hafnium, chromium, molybdenum, cobalt, nickel, tungsten and many rare earth metals are also suitable for use in Ziegler-Natta catalysts. The transition metal compound is usually a halide or oxyhalide, an organic metal halide or purely a metal organic compound. In the last-mentioned compounds, there are only organic ligands attached to the transition metal.

In an embodiment, the procatalyst has the formula Mga Me (OR)ₑ X_{f}(ED)_{g} wherein R is an aliphatic or aromatic hydrocarbon radical having 1 to 14 carbon atoms or COR′ wherein R′ is a aliphatic or aromatic hydrocarbon radical having 1 to 14 carbon atoms; each OR group is the same or different; X is independently chlorine, bromine or iodine; ED is an electron donor; d is 0.5 to 56; e is 0, 1, or 2; f is 2 to 116; and g is >1 to 1.5 (d). Me is a transition metal selected from the group of titanium, zirconium, hafnium and vanadium. Some specific examples of suitable titanium compounds are: TiCl₃, TiCl₄, Ti(OC₂H₅)₂Br₂, Ti(OC₆H₅) Cl₃, Ti(OCOCH₃) Cl₃, Ti (acetylacetonate)₂Cl₂, TiCl₃ (acetylacetonate), and TiBr₄.

The magnesium compounds include magnesium halides such as MgCl₂ (including anhydrous MgCl₂), MgBr₂, and Mgl₂. Nonlimiting examples of other suitable compounds are Mg(OR)₂, Mg(OCO₂Et) and MgRCl where R is defined above. From 0.5 to 56 moles, or from 1 to 20 moles of the magnesium compounds are used per mole of transition metal compound. Mixtures of these compounds may also be used.

The procatalyst compound can be recovered as a solid using techniques known in the art, such as precipitation of the procatalyst or by spray drying, with or without fillers. Spray drying is a particularly preferred method for recovery of the procatalyst compound. Spray drying is taught in U.S. Pat. No. 5,290,745 and is hereby incorporated by reference. A further procatalyst including magnesium halide or alkoxide, a transition metal halide, alkoxide or mixed ligand transition metal compound, an electron donor and optionally, a filler can be prepared by spray drying a solution of said compounds from an electron donor solvent.

The electron donor is typically an organic Lewis base, liquid at temperatures in the range of from 0° C. to 200° C., in which the magnesium and transition metal compounds are soluble. The electron donor can be an alkyl ester of an aliphatic or aromatic carboxylic acid, an aliphatic ketone, an aliphatic amine, an aliphatic alcohol, an alkyl or cycloalkyl ether, or mixtures thereof, each electron donor having 2 to 20 carbon atoms. Among these electron donors, the preferred are alkyl and cycloalkyl mono-ethers having 2 to 20 carbon atoms; dialkyl, diaryl, and alkylaryl ketones having 3 to 20 carbon atoms; and alkyl, alkoxy, and alkylalkoxy esters of alkyl and aryl carboxylic acids having 2 to 20 carbon atoms. Mono-ether is defined herein as a compound that contains only one ether functional group in the molecule. For ethylene homo and co-polymerization, the most preferred electron donor is tetrahydrofuran. Other examples of suitable electron donors are methyl formate, ethyl acetate, butyl acetate, ethyl ether, dioxane, di-n-propyl ether, dibutyl ether, ethanol, 1-butanol, ethyl formate, methyl acetate, ethyl anisate, ethylene carbonate, tetrahydropyran, and ethyl propionate.

While an excess of electron donor may be used initially to provide the reaction product of transition metal compound and electron donor, the reaction product finally contains from 1 to 20 moles of electron donor per mole of transition metal compound, or from 1 to 10 moles of electron donor per mole of transition metal compound. The ligands include halogen, alkoxide, aryloxide, acetylacetonate, and amide anions.

Partial activation of the procatalyst can be carried out prior to the introduction of the procatalyst into the reactor. The partially activated catalyst alone can function as a polymerization catalyst but at greatly reduced and commercially unsuitable catalyst productivity. Complete activation by additional cocatalyst is required to achieve full activity. The complete activation occurs in the polymerization reactor via addition of cocatalyst.

The catalyst procatalyst can be used as dry powder or slurry in an inert liquid. The inert liquid is typically a mineral oil. The slurry prepared from the catalyst and the inert liquid has a viscosity measured at 1 sec⁻¹ of at least 500 cp (500 mPa·s) at 20° C. Nonlimiting examples of suitable mineral oils are the Kaydol™ and Hydrobrite™ mineral oils from Crompton.

In an embodiment of the polymerization process, the procatalyst undergoes in-line reduction using reducing agent(s). The procatalyst is introduced into a slurry feed tank; the slurry then passes via a pump to a first reaction zone immediately downstream of a reagent injection port where the slurry is mixed with the first reagent, as described below. Optionally, the mixture then passes to a second reaction zone immediately downstream of a second reagent injection port where it is mixed with the second reagent (as described below) in a second reaction zone. While only two reagent injection and reaction zones are described above, additional reagent injection zones and reaction zones may be included, depending on the number of steps required to fully activate and modify the catalyst to allow control of the specified fractions of the polymer molecular weight distribution. Methods to control the temperature of the catalyst procatalyst feed tank and the individual mixing and reaction zones are provided.

Depending on the activator compound used, some reaction time may be required for the reaction of the activator compound with the catalyst procatalyst. This is conveniently done using a residence time zone, which can consist either of an additional length of slurry feed pipe or an essentially plug flow holding vessel. A residence time zone can be used for both activator compounds, for only one or for neither, depending entirely on the rate of reaction between activator compound and catalyst procatalyst.

Exemplary in-line reducing agents are aluminum alkyls and aluminum alkyl chlorides of the formula AlRₓCl_{y} where X+Y=3 and y is 0 to 2 and R is a C1 to C14 alkyl or aryl radical. Nonlimiting examples of in-line reducing agents include diethylaluminum chloride, ethylaluminum dichloride, di-isobutyaluminum chloride, dimethylaluminum chloride, methylaluminum sesquichloride, ethylaluminum sesquichloride, triethylaluminum, trimethylaluminum, triisobutylaluminum, tri-n-hexylaluminum, tri-n-octylaluminum, and dimethylaluminum chloride.

The entire mixture is then introduced into the reactor where the activation is completed by the cocatalyst. Additional reactors may be sequenced with the first reactor, however, catalyst is typically only injected into the first of these linked, sequenced reactors with active catalyst transferred from a first reactor into subsequent reactors as part of the polymer thus produced.

The cocatalysts, which are reducing agents, conventionally used are comprised of aluminum compounds, but compounds of lithium, sodium and potassium, alkaline earth metals as well as compounds of other earth metals than aluminum are possible. The compounds are usually hydrides, organometal or halide compounds. Conventionally, the cocatalysts are selected from the group comprising Al-trialkyls, Al-alkyl halides, Al-alkyl alkoxides and Al-alkyl alkoxy halides. In particular, Al-alkyls and Al-alkyl chlorides are used. These compounds are exemplified by trimethylaluminum, triethylaluminum, tri-isobutylaluminum, tri-n-hexylaluminum, dimethylaluminum chloride, diethylaluminum chloride, ethylaluminum dichloride and diisobutylaluminum chloride, isobutylaluminum dichloride and the like. Butyllithium and dibutylmagnesium are examples of useful compounds of other metals.

The bimodal medium density polyethylene composition may comprise two or more embodiments discussed herein.

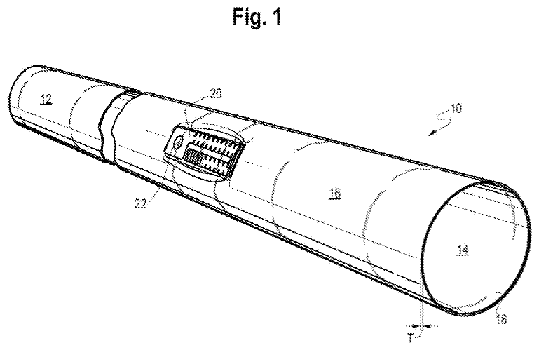

Also disclosed herein is a microirrigation drip tape. The microirrigation drip tape comprises the bimodal medium density polyethylene composition described herein. A “microirrigation drip tape” is an extruded structure having an annular wall composed of the bimodal medium density polyethylene composition, the annular wall defining an annular passageway. In other words, the microirrigation drip tape is a tube through which water, or another liquid, may pass. FIG. 1 depicts a microirrigation drip tape 10 having an annular wall 12 that defines an annular passageway 14. The annular wall 12 has an exterior surface 16 and an interior surface 18. In an embodiment, the annular wall 12 of the microirrigation drip tape 10 is composed solely of the bimodal medium density polyethylene composition.

Emitters 20 are arranged at intervals along the interior surface 18 of the annular wall 12. An “emitter” is an insert that controls the rate at which water or another liquid passes through an opening 22 (e.g., a hole, a slit, or a perforation) made in the annular wall by mechanical drilling, cutting or laser cutting. The emitter 20 is placed on the interior surface 18 of the annular wall 12 after the microirrigation drip tape 10 exits the extruder while the formulation is in transition from the molten state to the rigid state, which enables the emitter 20 to adhere to the microirrigation drip tape 10 via welding. The adherence of the emitter 20 to the annular wall 12 is sufficient to keep the emitter 20 in a fixed position, and to maintain a leak-proof seal between the annular wall 12 and the emitter 20.

The microirrigation drip tape has a cross-sectional shape. Nonlimiting examples of suitable cross-sectional shapes for the microirrigation drip tape include ellipse, polygon, and combinations thereof. A “polygon” is a closed-plane figure bounded by at least three sides. The polygon can be a regular polygon, or an irregular polygon having three, four, five, six, seven, eight, nine, ten or more sides. Nonlimiting examples of suitable polygonal shapes include triangle, square, rectangle, diamond, trapezoid, parallelogram, hexagon and octagon. An “ellipse” is a plane curve such that the sum of the distances of each point in its periphery from two fixed points, the foci, are equal. The ellipse has a center which is the midpoint of the line segment linking the two foci. The ellipse has a major axis (the longest diameter through the center). The minor axis is the shortest line through the center. The ellipse center is the intersection of the major axis and the minor axis. A “circle” is a specific form of ellipse, where the two focal points are in the same place (at the circle's center). Nonlimiting examples of ellipse shapes include circle, oval, and ovoid. FIG. 1 depicts a microirrigation drip tape 10 having a circle cross-sectional shape.

### Test Methods

### Density

Density is measured in accordance with ASTM D792, and expressed in grams/cm³ (g/cm³ or g/cc).

### Melt Flow Rate (I2, I5 and I21)

The procedure described in ASTM D1238 is followed to determine the melt flow rate. This test method covers the determination of the rate of extrusion of molten thermoplastic resins using an extrusion plastometer. After a specified preheating time of 7 (+/−0.5) min, resin is extruded through a die with a specified length and orifice diameter under prescribed conditions of temperature, load, and piston position in the barrel. Method B of ASTM D1238 is used. Method B is an automatically timed method. Here, the sample is extruded from the melt index machine and the piston travel is timed over a pre-determined distance, the timing is performed automatically by a moveable arm position below the load frame. The pre-determined distance is 6.35 mm for a I2 of up to 10 g/10 min and 25.4 mm for a I2 of >10 g/10 min. The weight of the extrudate is determined from the volume (distance x bore area) and the melt density. The melt density is taken to be 0.7636 g/cm³ for polyethylene. The data are reported as MFR in g/10 min or dg/min. Samples can be run with loads of 21.6 kg, 5.0 kg or 2.16 kg (i.e., I21, I5 or I2, respectively).

### Notched Constant Tensile Load (NCTL)

Notched constant tensile load (NCTL) failure time in hours is measured at 30% yield stress in accordance with ASTM D5397. This test is conducted at 50° C. in a solution of 10% Igepal. The sample thickness is 0.075″ thick and are notched to a depth of 20% of the thickness. The stress applied is equal to 30% of yield stress of the resin measured at room temperature.

### Tensile Stress at Yield

Tensile stress at yield of the bimodal medium density polyethylene composition in MPa is measured using samples prepared by compression molding pellets according to ASTM D638 (2 inch/min crosshead speed) (5.08 cm/min crosshead speed).

### Dynamic Mechanical Spectroscopy (Crossover G′=G″)

Each sample was compression molded into a disk for rheology measurement. The disks were prepared by pressing the samples into 3.0 mm thick plaques, and were subsequently cut into “25 mm diameter disks. The resin rheology was measured on the ARES-G2 model Rheometer from TA Instruments. The ARES is a strain controlled rheometer. A rotary actuator (servomotor) applies shear deformation in the form of Strain to a sample. In response, the sample generates torque, which is measured by the transducer. Strain and torque are used to calculate dynamic mechanical properties, such as modulus and viscosity. The Viscoelastic properties of the sample were measured, in the melt, using a “25 mm diameter parallel plate set up, at 190° C., and as a function of varying frequency (range 0.01 s-1 to 100 s-1). A small constant strain (5%) was applied to ensure the measurement was in the linear Viscoelastic region. The storage modulus (G′), loss modulus (G″), tan delta (G″/G′), and complex viscosity (eta) of the resin were determined. Crossover G′=G″ is recorded in kPa as a measure of melt elasticity, with lower the value, higher melt elasticity.

Differential Scanning calorimetry (DSC)

DSC thermogram are obtained using TA Instrument Discover DSC instrument and is used to measure melting temperature (Tm) and crystallization temperature (Tc) of polyethylene samples. A 5 to 8 mg crimped sample is heated, at a rate of 10° C./min to 150° C. for PE. The sample is held isothermally at desired temperature for five minutes. Then the sample is cooled at a rate of 10° C./min to −40° C. for the cooling curve data. The sample is held isothermally at desired temperature for five minutes. The sample is then heated at a rate of 10° C./min to desired temperature for the second heat curve data. Melting peaks (Tm), and crystallization peaks (Tc), of each polymer sample are processed using the software Universal Analysis provided by TA Instruments and recorded.

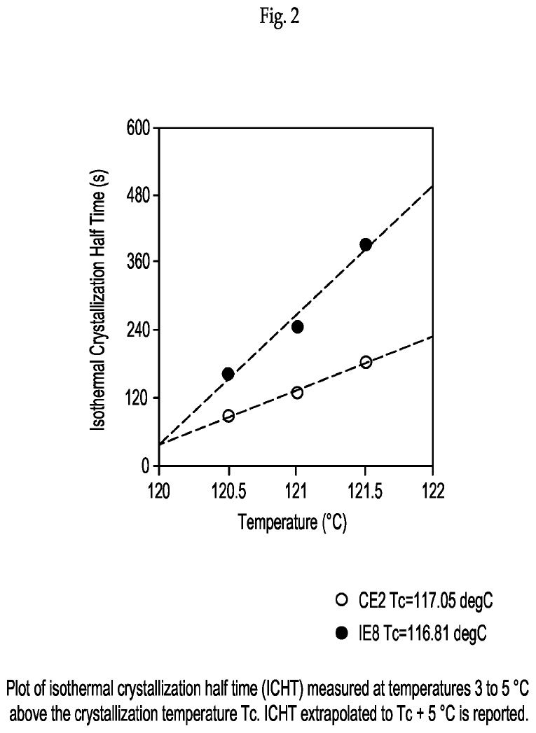

For determining isothermal crystallization half time (ICHT) a separate 5 to 8 mg crimped sample is heated, at the rate of 10° C./min to 150° C. for PE. The sample is held isothermally at desired temperature for five minutes. Then the sample is cooled rapidly to the desired isothermal temperature and held isothermally for 60 minutes. The ICHT is taken as the time taken from the onset of the crystallization isotherm to the peak in seconds. ICHT is measured for at least three temperatures which are 3 to 5° C. greater than the crystallization peak temperature Tc and at least 0.5° C. apart. ICHT reported at Tc+5° C. is obtained by using a linear regression from the measured ICHT temperatures. FIG. 2 shows a plot of isothermal crystallization half time (ICHT) measured at temperatures 3 to 5° C. above the crystallization temperature Tc. ICHT extrapolated to Tc+5° C. is reported.

### Absolute GPC (Molecular Weight Distribution)

The chromatographic system consisted of a PolymerChar GPC-IR (Valencia, Spain) high temperature GPC chromatograph equipped with an internal IR5 infra-red detector (IR5) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° Celsius and the column compartment and detectors were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards were dissolved at 80° C. with gentle agitation for 30 minutes. The polystyrene standard peak molecular weights were converted to ethylene-based polymer molecular weights using Eq. 4 (as described in Williams and Ward, J. Polym. Sci., Polym. Let., 6, 621 (1968)).:

$${M}_{polyethylene} = A \times {( {M}_{polystyrene} )}^{B} \qquad Eq . 4$$

where M is the molecular weight, A has a value of 0.4315 and B is equal to 1.0.

A fifth order polynomial was used to fit the respective ethylene-based polymer-equivalent calibration points.

The total plate count of the GPC column set was performed with decane without further dilution. The plate count (Eq. 5) and symmetry (Eq. 6) were measured on a 200 microliter injection according to the following equations:

$$Plate Count = 5.54 \times {( \frac{{RV}_{Peak M ax}}{Peak Width at half height} )}^{2} \qquad Eq . 5$$

where RV is the retention volume in milliliters, the peak width is in milliliters, the peak max is the maximum height of the peak, and half height is one half of the height of the peak maximum.

$$Symmetry = \frac{( Rear Peak {RV}_{one tenth height} - {RV}_{Peak ma x} )}{( {RV}_{Peak ma x} - Front Peak {RV}_{one tenth height} )} \qquad Eq . 6$$

where RV is the retention volume in milliliters and the peak width is in milliliters, Peak max is the maximum position of the peak, one tenth height is one tenth of the height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 3 hours at 160° C. under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Eq. 7. Processing of the flow marker peak was done via the PolymerChar GPCOne™ Software. Acceptable flowrate correction is such that the effective flowrate should be within 0.5% of the nominal flowrate.

$$Flow {rate}_{effective} = Flow {rate}_{nominal} \times ( RV ( F {M}_{calibrated} ) / RV ( F {M}_{Sample} ) ) \qquad Eq . 7$$

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

Absolute weight-average molecular weight (MW (Abs)) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™).

Absolute number-average molecular weight (Mn_{(Abs)}), weight-average (Mw_{(Abs)}) and absolute z-average molecular weight (Mz_{(Abs)}) are calculated according to Eqs 8-10 as follows:

$$Mn ( Abs ) = \frac{{\sum }^{i} {IR}_{i}}{{\sum }^{i} ( \frac{{IR}_{i}}{{M}_{{Absolute}_{i}}} )} \qquad Eq . 8$$

$$Mw ( Abs ) = \frac{{\sum }^{i} ( {IR}_{i} * {M}_{{Absolute}_{i}} )}{{\sum }^{i} ( {IR}_{i} )} \qquad Eq . 9$$

$$Mz ( Abs ) = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad Eq . 10$$

### Average Short Chain Branching Frequency

A calibration for the IR5 detector ratioing was performed using at least ten ethylene-based polymer standards (ethylene-based polymer homopolymer and ethylene/octene copolymers) of known short chain branching (SCB) frequency (The comonomer content of the reference materials is determined using 13C NMR analysis in accordance with techniques described, for example, in U.S. Pat. No. 5,292,845 (Kawasaki, et al.) and by J. C. Randall in Rev. Macromol. Chem. Phys., C29, 201-317, which are incorporated herein by reference), ranging from homopolymer (0 SCB/1000 total C) to approximately 50 SCB/1000 total C, where total C is equal to the carbons in backbone plus the carbons in branches. Each standard had a weight-average molecular weight from 36,000 g/mole to 126,000 g/mole and had a molecular weight distribution from 2.0 to 2.5, as determined by GPC.

The “IR5 Height Ratio (or “IR5 Methyl Channel Height/IR5 Measurement Channel Height”)” of “the baseline-subtracted height response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Height Ratio” was constructed in the form of the following Eq. 11:

$$wt \% Comonomer = {A}_{0} + [ {A}_{1} ( IR {5}_{Methyl Channel Area} / IR {5}_{Measurement Channel Area} ) ] \qquad Eq . 11$$

with coefficients A₀=−51.08 and A₁=250.1.

Therefore, a GPC-CC (GPC-Comonomer Content) plot (comonomer wt % vs. lgMW) can be obtained. End-Group Correction of the wt % Comonomer data can be made via knowledge of the termination mechanism if there is significant spectral overlap with the comonomer termination (methyls) via the molecular weight determined at each chromatographic slice. SCB frequency for each slice, SCBᵢ of lgMwᵢ can be calculated by the relationship

$$S C {B}_{i} = {\sum }^{i} ( 0.8 * comonomer wt {\%}_{i} ) \qquad Eq . 12$$

for ethylene-octene copolymers
and

$$S C {B}_{i} = {\sum }^{i} ( 0.6 * comonomer wt {\%}_{i} ) \qquad Eq . 13$$

for ethylene-hexene copolymers.

Average SCB frequency over the entire distribution can then be calculated

$$Average S C B = {\sum }^{i} ( wt G P {C}_{i} * S C {B}_{i} ) . \qquad Eq . 14$$

### Deconvolution of GPC Chromatogram

The fitting of the chromatogram into a high molecular weight (HMW) and low molecular weight (LMW) component fraction was accomplished using a Flory distribution which was broadened with a normal distribution function as follows:

For the log M axis, 501 equally-spaced Log (M) points, spaced by 0.01, were established between 2 and 7 representing the molecular weight range between 100 and 10,000,000 where Log is the logarithm function to the base 10.

At any given Log (M), the population of the Flory distribution was in the form of Eq. 15:

$${dW}_{f} = {( \frac{2}{{M}_{w}} )}^{3} ( \frac{{M}_{w}}{0.868588961964} ) {M}^{2} e ( \frac{- 2 M}{{M}_{w}} ) \qquad Eq . 15$$

where Mw is the weight-average molecular weight of the Flory distribution and M is the specific x-axis molecular weight point, (10\hat{ }[Log (M)]).

The Flory distribution weight fraction was broadened at each 0.01 equally-spaced log(M) index according to a normal distribution function, of width expressed in Log (M), σ; and current M index expressed as Log(M), μ.

$${f}_{( L o gM , μ , σ )} = \frac{{e}^{- \frac{{( L o g M - μ )}^{2}}{2 {σ}^{2}}}}{σ \sqrt{2 π}} \qquad Eq . 16$$

It should be noted that before and after the spreading function has been applied that the area of the distribution (dW_{f}/dLogM) as a function of Log (M) is normalized to unity.

Two weight-fraction distributions, dW_{f 1} and dW_{f 2}, for LMW and HMW components or components 1 and 2 were expressed with two unique Mw target values, Mw₁ and Mw₂ and with overall component compositions A₁ and A₂. Both distributions were broadened with the same width, σ. The two distributions were summed as follows:

$${dW}_{f} = {A}_{1} {dW}_{f 1} + {A}_{2} {dW}_{f 2} \qquad Eq . 17$$

$$where :$$

$${A}_{1} + {A}_{2} = 1$$

The weight fraction result of the measured (from Conventional GPC) GPC molecular weight distribution was interpolated along 501 log M points using a 2^{nd}-order polynomial. Microsoft Excel™ 2010 Solver was used to minimize the sum of squares of residuals for the equally-spaces range of 501 Log M points between the interpolated chromatographically determined molecular weight distribution and the two broadened Flory distribution components (σ₁ and σ₂), weighted with their respective component compositions, A₁ and A₂.

The iteration starting values for the components are as follows:
Component 1: Mw=30,000, σ=0.300, and A=0.475
Component 2: Mw=250,000, σ=0.300, and A=0.475
(Note σ₁=σ₂ and A₁+A₂=1)

The bounds for components 1 and 2 are such that σ is constrained such that σ>0.001, yielding an Mw/Mn of approximately 2.00 and σ<0.450, yielding a Mw/Mn of approximately 5.71. The composition, A, is constrained between 0.000 and 1.000. The Mw is constrained between 2,500 and 2,000,000. The composition, A, is constrained between 0.000 and 1.000. The Mw is constrained between 2,500 and 2,000,000.

The “GRG Nonlinear” engine was selected in Excel Solver™ and precision was set at 0.00001 and convergence was set at 0.0001. The solutions were obtained after convergence (in all cases shown, the solution converged within 60 iterations).

Average short chain branching frequency distributions for the LMW and HMW components are estimated by proportioning the short chain branching based on the weight fraction distribution of the two components, dW_{f 1} and dW_{f 2}, obtained from the deconvolution described above and averaged for each component.

### Extrusion Line Speed

The extrusion line speed is a key parameter in microirrigation drip tape production, as it determines the machine occupancy per produced unit. A high line speed is therefore seen beneficial for the tape manufacturer. The line has been optimized in die and pin geometry to allow a line speed as high as possible. To measure maximum extrusion line speed, the line speed is increased incrementally from 200 m/min to 250, 300, 350 and 400 m/min. The line speed is recorded by the extrusion parameters that are displayed by the control unit. The highest line speed where the tape is running stable for several minutes, e.g., 30 minutes, is recorded and is deemed as the maximum extrusion line speed for the example. In case of a breakage of the extrudate at this speed, the lower line speed—where the product is still running stable—is regarded as being the maximum extrusion line speed.

### EXAMPLES

### Materials Used

The following materials were included in the examples discussed below.

FINGERPRINT™ DFDC 7525 NT, a unimodal ethylene/1-hexene copolymer medium density polyethylene is used as Comparative Example (CE) 1 and is commercially available from The Dow Chemical Company (Midland, MI).

### Preparation of Comparative Examples 2-5 and Inventive Examples 6-8

Example bimodal medium density polyethylene compositions designated as Comparative Examples 2, 3, 4 and 5, and Inventive Examples 6, 7, and 8 are produced using a catalyst system including a procatalyst, UCAT™ J (commercially available from Univation Technologies, LLC, Houston, TX), and a cocatalyst, triethylaluminum (TEAL), in a gas phase polymerization process. The UCAT™ J catalyst is partially activated by contact at room temperature with an appropriate amount of a 50 percent mineral oil solution of tri-n-hexyl aluminum (TNHA). The catalyst slurry is added to a mixing vessel. While stirring, a 50 percent mineral oil solution of tri-n-hexyl aluminum (TNHA) is added at ratio of 0.17 moles of TNHA to mole of residual THF in the catalyst and stirred for at least 1 hour prior to use. Ethylene (C2) and optionally, 1-hexene (C6) are polymerized in two fluidized bed reactors. Each polymerization is continuously conducted, after equilibrium is reached, under the respective conditions, as shown below in Tables 1A and 1B. Polymerization is initiated in the first reactor by continuously feeding the catalyst and cocatalyst (trialkyl aluminum, specifically tri ethyl aluminum or TEAL) into a fluidized bed of polyethylene granules, together with ethylene, hydrogen, and 1-hexene. The resulting polymer, mixed with active catalyst, is withdrawn from the first reactor, and transferred to the second reactor, using second reactor gas as a transfer medium. The second reactor also contains a fluidized bed of polyethylene granules. Ethylene, hydrogen, and hexene are introduced into the second reactor, where the gases come into contact with the polymer and catalyst from the first reactor. Inert gases, nitrogen and isopentane, make up the remaining pressure in both the first and second reactors. In the second reactor, the cocatalyst (TEAL) is again introduced. The final product blend is continuously removed. Table 1A lists the polymerization conditions for CE 2, CE 3, CE 4, and CE 5. Table 1B lists the polymerization conditions for IE 6, IE 7, and IE 8.

The product is combined with additives (500 ppm calcium stearate, 1300 ppm Irganox™ 1010, and 1300 ppm Irgafos™ 168) and fed to a continuous mixer (Kobe Steel, Ltd. LCM-100 continuous mixer), which is closed coupled to a gear pump, and equipped with a melt filtration device and an underwater pelletizing system.

The properties of the Comparative Examples and Inventive Examples are provided below in Tables 2A and 2B. In Tables 2A and 2B, “HMW” refers to the high molecular weight polyethylene component, and “LMW” refers to the low molecular weight polyethylene component.

Microirrigation drip tapes are formed from the bimodal medium density polyethylene composition using a Maillefer International Oy Extruder MXC 60-36D with a diameter of 60 mm and a length/diameter (L/D) ratio of 36. The extruder uses a suitable temperature profile to achieve a melt temperature of 240° C. The extruder is equipped with an annular die having a 34.5 mm diameter and a pin having a 32.5 mm diameter (gap of 1 mm). Each microirrigation drip tape has an internal diameter of 16 mm. Thickness of the annular wall is adjusted by changing the rotations per minute (rpm) of the extruder, and the line speed of the extruder. Then, each microirrigation drip tape is calibrated and water cooled. During cooling of the tape, just after exiting the extruder, emitters are placed on the interior surface of the annular wall. Down the line, perforations in the annular wall at the emitters are made online before winding the tape by a mechanical drilling device or laser cut. The maximum extrusion line speed is provided in Tables 2A and 2B.

High speed processing of tapes is a key property and need for the efficient production of irrigation tapes. Processing trials have been performed on a Maillefer Test line PIL032-miniFT. This line reflects an entry model for the drip irrigation market that is readily available from Maillefer upon ordering. The line has been modified with a belt haul-off, type RCI 32, being capable for higher line speeds of 300 to 400 m/min for development purposes. For the calibration a Maillefer Vacuum trough of the type BRI 32-16 m with dryer has been used.

TABLE 1A
Comparative Examples 2-5 Polymerization Conditions

| | CE 2 | | CE 3 | | CE 4 | | CE 5 | |
|---|---|---|---|---|---|---|---|---|
| Reactor | 1 | 2 | 1 | 2 | 1 | 2 | 1 | 2 |
| Catalyst | UCAT ™ J | | UCAT ™ J | | UCAT ™ J | | UCAT ™ J | |
| Temperature | 80 | 95 | 85 | 110 | 85 | 110 | 85 | 110 |
| (° C.) | | | | | | | | |
| Pressure (psig) | 347 | 392 | 348 | 398 | 348 | 399 | 348 | 398 |
| Pressure (MPa) | 2.39 | 2.70 | 2.40 | 2.74 | 2.40 | 2.75 | 2.40 | 2.74 |
| C2 Partial | 35.5 | 100 | 38 | 98 | 34 | 105 | 31 | 100 |
| Pressure (psi) | | | | | | | | |
| C2 Partial | 0.24 | 0.69 | 0.26 | 0.68 | 0.23 | 0.72 | 0.21 | 0.69 |
| Pressure (MPa) | | | | | | | | |
| H2/C2 Molar | 0.021 | 0.6 | 0.047 | 1.8 | 0.026 | 1.8 | 0.020 | 1.8 |
| Ratio | | | | | | | | |
| C6/C2 Molar | 0.1114 | 0.007 | 0.0449 | 0.0003 | 0.0582 | 0.0003 | 0.0620 | 0.0003 |
| Ratio | | | | | | | | |
| IC5% | 12.08 | 4.99 | 11.92 | 5.13 | 11.92 | 5.08 | 11.92 | 5.05 |
| Cat Feed Rate | 2.40 | | 4.37 | — | 5.30 | — | 5.90 | — |
| (cc/hr) | | | | | | | | |
| Cocatalyst | 2.5% | 2.5% | 2.5% | 2.5% | 2.5% | 2.5% | 2.5% | 2.5% |
| | TEAL | TEAL | TEAL | TEAL | TEAL | TEAL | TEAL | TEAL |
| Cocat. Feed | 171 | 111 | 247 | 200 | 278 | 200 | 295 | 199 |
| Rate (cc/hr) | | | | | | | | |
| Production | 29.4 | 24.7 | 34.2 | 25.5 | 37.1 | 29.5 | 31.6 | 32.7 |
| Rate (lb/hr) | | | | | | | | |
| Bed Weight | 100 | 151 | 100 | 168 | 101 | 163 | 100 | 163 |
| (lbs) | | | | | | | | |
| Bed Weight | 45.4 | 68.5 | 45.4 | 76.2 | 45.8 | 73.9 | 45.4 | 73.9 |
| (kg) | | | | | | | | |

TABLE 1B
Inventive Examples 6-8 Polymerization Conditions

| | IE 6 | | IE 7 | | IE 8 | |
|---|---|---|---|---|---|---|
| Reactor | 1 | 2 | 1 | 2 | 1 | 2 |
| Catalyst | UCAT ™ J | | UCAT ™ J | | UCAT ™ J | |
| Temperature | 80 | 95 | 80 | 100 | 80 | 100 |
| (° C.) | | | | | | |
| Pressure (psig) | 347 | 394 | 347 | 393 | 347 | 394 |
| Pressure | 2.40 | 2.72 | 2.39 | 2.71 | 2.39 | 2.71 |
| (MPa) | | | | | | |
| C2 Partial | 31 | 103 | 33.5 | 83.3 | 34.6 | 108.5 |
| Pressure (psi) | | | | | | |
| C2 Partial | 0.21 | 0.71 | 0.23 | 0.57 | 0.24 | 0.75 |
| Pressure | | | | | | |
| (MPa) | | | | | | |
| H2/C2 Molar | 0.015 | 1.8 | 0.045 | 1.8 | 0.03 | 1.4 |
| Ratio | | | | | | |
| C6/C2 Molar | 0.126 | 0.020 | 0.042 | 0.052 | 0.048 | 0.021 |
| Ratio | | | | | | |
| IC5% | 7.08 | 5.04 | 12.0 | 4.97 | 12.1 | 4.97 |
| Cat Feed Rate | 5.0 | — | 4.0 | — | 3.3 | — |
| (cc/hr) | | | | | | |
| Cocatalyst | 2.5% | 2.5% | 2.5% | 2.5% | 2.5% | 2.5% |
| | TEAL | TEAL | TEAL | TEAL | TEAL | TEAL |
| Cocat. Feed | 225 | 145 | 284 | 140 | 253 | 139 |
| Rate (cc/hr) | | | | | | |
| Production | 32.7 | 25.6 | 32.7 | 27.5 | 33.6 | 29.3 |
| Rate (lb/hr) | | | | | | |
| Bed Weight | 91 | 150 | 89 | 150 | 88 | 154 |
| (lbs) | | | | | | |
| Bed Weight | 41.3 | 68.2 | 40.5 | 68.2 | 40.0 | 70.0 |
| (kg) | | | | | | |

TABLE 2A
Properties of Comparative Examples 1-5

| | CE 1 | CE 2 | CE 3 | CE 4 | CE 5 |
|---|---|---|---|---|---|
| Modality | Unimodal | Bimodal | Bimodal | Bimodal | Bimodal |
| Comonomer | Hexene | Hexene | Hexene | Hexene | Hexene |
| HMW | N/A¹ | | | | |
| Density (g/cm³) | | 0.9195 | 0.9317 | 0.9278 | 0.9267 |
| I21 (g/10 min) | | 0.6 | 0.9 | 0.5 | 0.4 |
| Wt. fraction % | | 54 | 57 | 56 | 50 |
| Avg. SCB/1000 C. | | 5.4 | 2.1 | 2.6 | 3.3 |
| Mw | | 505,006 | 404,557 | 477,515 | 522,945 |
| LMW | N/A¹ | | | | |
| Density (g/cm³)² | | 0.9648 | 0.9813 | 0.9849 | 0.9777 |
| Avg. SCB/1000 C. | | 4.6 | 1.4 | 1.4 | 1.8 |
| Mw | | 67,675 | 26,983 | 22,565 | 25,379 |
| LMW SCB/HMW | N/A¹ | 0.85 | 0.67 | 0.54 | 0.55 |
| SCB | | | | | |
| Composition | | | | | |
| Properties | | | | | |
| Density (g/cm3) | 0.939 | 0.9398 | 0.9524 | 0.9521 | 0.9515 |
| I21 (g/10 min) | 22 | 8.3 | 18 | 18 | 18 |
| I21/I2 | 130 | 64 | 77 | 111 | 121 |
| Mn | 10,270 | 28,160 | 11,674 | 11,482 | 12,112 |
| Mw | 302,530 | 297,514 | 241,923 | 23,497 | 265,392 |
| Mz | 5,920,250 | 1,523,327 | 1,684,525 | 1,634,642 | 1,512,664 |
| Mw/Mn | 25.62 | 9.93 | 20.72 | 22.08 | 21.91 |
| Avg. SCB/1000 C. | | 5.0 | 1.8 | 2.1 | 2.6 |
| Tensile Stress at | 19.3 | 20.1 | 24.8 | 24.8 | 24.8 |
| Yield (MPa) | | | | | |
| NCTL Failure Time | 560 | >1000 | 108 | 161 | 151 |
| @ 30% Yield Stress | | | | | |
| (hrs) | | | | | |
| DSC Melting | 126 | 129 | 130 | 130 | 130 |
| Temperature Tm | | | | | |
| (° C.) | | | | | |
| DSC Crystallization | 115.63 | 117.05 | 118.67 | 118.61 | 118.21 |
| Temperature Tc (° C.) | | | | | |
| Isothermal | 289 | 233 | 342 | 327 | 261 |
| Crystallization Half- | | | | | |
| Time at Tc + 5° C. | | | | | |
| (sec) | | | | | |
| Crossover | 14.8 | 54.8 | 50.1 | 38.3 | 36.1 |
| G′ = G″ (kPa) | | | | | |
| Extensional Strain at | 4.92 | 3.85 | 3.49 | 3.55 | 4.06 |
| break | | | | | |
| (43-Crossover | N/A¹ | −7.17 | −22.76 | −15.43 | −4.29 |
| G′ = G″) + | | | | | |
| 1230*(0.9731-LMW | | | | | |
| Density) − 5.5745 | | | | | |
| (43-Crossover | N/A¹ | −6.72 | −29.64 | −17.56 | −6.25 |
| G′ = G″) − (54.4/LMW | | | | | |
| SCB) + 16.9 | | | | | |
| Maximum Extrusion | 250 | Did not extrude | 200 | 200 | 250 |
| Line Speed (m/min) | | | | | |

¹Comparative Example 1 is a unimodal resin and so these parameters are not applicable.
²The low molecular weight density is the calculated LMW density calculated using Eq. A:
$Calculated LMW Density = \frac{( 1 - HMW wt . fraction )}{( \frac{1}{Density} - \frac{HMW wt . fraction}{HMW density} )} \qquad Eq . A$

TABLE 2B
Properties of Inventive Examples 6-8

| | IE 6 | IE 7 | IE 8 |
|---|---|---|---|
| Modality | Bimodal | Bimodal | Bimodal |
| Comonomer | Hexene | Hexene | Hexene |
| HMW | | | |
| Density (g/cm³) | 0.9164 | 0.9310 | 0.9249 |
| I21 (g/10 min) | 0.5 | 0.7 | 0.62 |
| Wt. fraction % | 56 | 54 | 53 |
| Avg. SCB/1000 C. | 9.0 | 2.6 | 4.3 |
| Mw | 431,052 | 418,028 | 454,891 |
| LMW | | | |
| Density (g/cm³)¹ | 0.9721 | 0.9629 | 0.9692 |
| Avg. SCB/1000 C. | 7.1 | 4.7 | 3.6 |
| Mw | 30,849 | 21,141 | 30,885 |
| LMW SCB/HMW SCB | 0.79 | 1.81 | 0.84 |
| Composition Properties | | | |
| Density (g/cm³) | 0.9401 | 0.9454 | 0.9452 |
| I21 (g/10 min) | 15 | 21 | 22 |
| I21/I2 | 119 | 88 | 96 |
| Mn | 12,546 | 11,229 | 13,954 |
| Mw | 229,373 | 227,067 | 233,913 |
| Mz | 1,344,810 | 1,536,884 | 1,336,196 |
| Mw/Mn | 18.28 | 20.22 | 16.76 |
| Avg. SCB /1000 C. | 8.1 | 3.6 | 4.0 |
| Tensile Stress at Yield (MPa) | 20.8 | 22.5 | 23.0 |
| NCTL Failure Time @ 30% Yield Stress (hrs) | >1000 | 189 | >1000 |
| DSC Melting Temperature Tm (° C.) | 127 | 128 | 128 |
| DSC Crystallization Temperature Tc (° C.) | 116.75 | 116.81 | 117.16 |
| Isothermal Crystallization Half-Time at Tc + 5° C. (sec) | 363 | 452 | 419 |
| Crossover | 33.7 | 42.0 | 37.1 |
| G′ = G″ (kPa) | | | |
| Extensional Strain at break | 1,164 | 464 | 1544 |
| (43-Crossover | 601 | 333 | 1168 |
| G′ = G″ + 1230*(0.9731-LMW Density) − 5.5745 | | | |
| (43-Crossover | 4.96 | 7.99 | 5.14 |
| G′ = G″) − (54.4/LMW SCB) + 16.9 | | | |
| Maximum Extrusion Line Speed (m/min) | 350 | 400 | 400 |

¹The low molecular weight density is the calculated LMW density calculated using Eq. A:
$Calculated LMW Density = \frac{( 1 - HMW wt . fraction )}{( \frac{1}{Density} - \frac{HMW wt . fraction}{HMW density} )} \qquad Eq . A$

As can be seen from Tables 1A and 1B, for the Inventive Examples, a higher amount of comonomer is being added to the second reactor in which the LMW polyethylene component is produced. This in turn leads to both a lower LMW polyethylene component density and a higher average short chain branching frequency in the LMW polyethylene component, as can be seen from Tables 2A and 2B. Without being bound by any theory, these properties, along with crossover G′=G″, contribute to a processability advantage by modifying crystallization rates (as measured by isothermal crystallization half-time at Tc+5° C.). As can be seen in Tables 2A and 2B, the isothermal crystallization half-time at Tc+5° C. is significantly longer in the Inventive Examples in comparison to the Comparative Examples. Also, the Inventive Examples satisfy the equation: [43.0−Crossover G′=G″]+1230*(0.9731−Calculated LMW Density)−5.5745≥0 (Eq. 2) as well as the equation [43−Crossover G′=G″]−(54.5/LMW SCB)+16.9≥0 (Eq. 3). Inventive Examples 6, 7, and 8 provide a value of 5.24, 7.85, and 4.91, respectively, for the left side of Eq. 2. Meanwhile, Comparative Examples 2, 3, 4, and 5 provide a value of −5.25, −23.23, −14.95, and −4.82, respectively, for the left side of Eq. 2. Inventive Examples 6, 7, and 8 provide a value of 7.82, 6.39, and 7.71, respectively, for the left side of Eq. 3. Meanwhile, Comparative Examples 2, 3, 4, and 5 provide a value of −6.64, −30.82, −18.43, and −6.59, respectively, for the left side of Eq. 3. The Inventive Examples have better processability with longer crystallization rates which results in less breaks and pinholes during processing. Inventive Example 6 can be extruded at line speeds of 350 m/min, and Inventive Examples 7 and 8 can be extruded at lines speeds of 400 m/min. The Comparative Examples cannot be extruded at these higher speeds. Without being bound by any theory, the Inventive Examples combination of properties, including a specific crossover G′=G″ (which is indicative of melt elasticity), a lower calculated low molecular weight density, a higher average SCB frequency, and a longer isothermal crystallization half-time at Tc+5° C., allows the composition to be extruded at higher speeds when compared to the Comparative Examples.

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A bimodal medium density polyethylene composition comprising (i) a high molecular weight (HMW) polyethylene component comprising an ethylene/α-olefin copolymer; and (ii) a low molecular weight (LMW) polyethylene component comprising an ethylene/α-olefin copolymer; the bimodal medium density polyethylene composition having the following:
(a) a density of from 0.937 to 0.949 g/cm³;
(b) a high load melt index (I21) from 12 to 30 g/10 min;
(c) an isothermal crystallization half-time at Tc+5° C. of greater than 350 seconds;
(d) an extensional strain at break of greater than 3.6;
(e) a crossover G′=G″ of from 30 to 45 kPa; and
(f) a calculated LMW density of the LMW polyethylene component of less than or equal to 0.974 g/cm³; and
wherein the crossover G′=G″ and the calculated LMW density satisfy the following equation:
$$[ 43. - Crossover {G}^{′} = {G}^{″} ] + 1230 \cdot ( 0.9731 - Calculated L M W Density ) - 5.5745 \geq 0$$

2. A bimodal medium density polyethylene composition comprising (i) a high molecular weight (HMW) polyethylene component comprising an ethylene/α-olefin copolymer; and (ii) a low molecular weight (LMW) polyethylene component comprising an ethylene/α-olefin copolymer; the bimodal medium density polyethylene composition having the following:
(a) a density of from 0.937 to 0.949 g/cm³;
(b) a high load melt index (I21) from 12 to 30 g/10 min;
(c) an isothermal crystallization half-time at Tc+5° C. of greater than 360 seconds;
(d) an extensional strain at break of greater than 3.6;
(e) a crossover G′=G″ of from 30 to 45 kPa;
(f) an average short chain branching (SCB) frequency of from 2.4 to 10.0 SCB per 1000 carbons; and
(g) an average short chain branching (SCB) frequency of the LMW polyethylene component of from 2.0 to 8.7 SCB per 1000 carbons; and
wherein the crossover G′=G″ and the average short chain branching (SCB) frequency of the LMW polyethylene component satisfy the following equation:
$$[ 43. - Crossover {G}^{′} = {G}^{″} ] - ( \frac{54.4}{L M W S C B} ) + 16.9 \geq 0$$

3. The bimodal medium density polyethylene composition of claim 1, wherein the HMW polyethylene component has a high load melt index (I21) of from 0.5 to 0.9 g/10 min and/or has a density of from 0.914 to 0.935 g/cm³.

4. The bimodal medium density polyethylene composition of claim 1, wherein the HMW polyethylene component is present in an amount of from 48 to 60 wt. %, based on total weight of the bimodal medium density polyethylene composition.

5. The bimodal medium density polyethylene composition of claim 1, wherein the bimodal medium density polyethylene composition has a molecular weight distribution, Mw/Mn, of from 12 to 30.

6. The bimodal medium density polyethylene composition of claim 1, wherein the bimodal medium density polyethylene composition has a notched constant tensile load failure time at 30% yield stress, as measured according to ASTMD5397, of greater than 100 hours.

7. The bimodal medium density polyethylene composition of claim 2, wherein the HMW polyethylene component has an average short chain branching (SCB) frequency, and the ratio of the average short chain branching (SCB) frequency of the LMW polyethylene component to the average short chain branching (SCB) frequency of the HMW polyethylene component is greater than 0.70.

8. A microirrigation drip tape comprising the bimodal medium density polyethylene composition of claim 1.
